(19) United States
(12) Patent Application Publication
(10) Pub. No.: US 2021/0304102 A1
(43) Pub. Date: Sep. 30, 2021

(54) AUTOMATICALLY ALLOCATING NETWORK INFRASTRUCTURE RESOURCE USAGE WITH KEY PERFORMANCE INDICATOR

(71) Applicant: Harness Inc., San Francisco, CA (US)

(72) Inventors: Puneet Saraswat, San Franicsco, CA (US); Rishikesh Singh, Sunnyvale, CA (US); Vikas Naiyar, San Francisco, CA (US); Soma Bhakta, San Francisco, CA (US); Hitesh Aringa, San Francisco, CA (US)

(73) Assignee: Harness Inc., San Francisco, CA (US)

(21) Appl. No.: 16/862,507

(22) Filed: Apr. 29, 2020

Related U.S. Application Data
(63) Continuation-in-part of application No. 16/831,811, filed on Mar. 27, 2020.

(51) Int. Cl. G06Q 10/06; G06Q 10/10; G06Q 10/04; G06F 11/34; G06F 11/30; G06F 17/18

(52) U.S. Cl. CPC G06Q 10/06375; G06Q 10/06393; G06Q 10/06315; G06F 17/18; G06Q 10/04; G06F 11/3409; G06F 11/3006; G06Q 10/10

(57) ABSTRACT

A system automatically correlates infrastructure usage and cost data to key performance indicators for a software system. The system continuously monitors the software system to detect operational events, key performance indicators, service degradation, and other events of a software system. The events may include memory usage, processor cycles used, and other data that may be expressed as time series data. The metrics such as for example metrics associated with operations initiated directly or indirectly by a user or customer request or service usage. The system then correlates network infrastructure resource usage with key performance indicator data. Based on detected correlations, the present system can automatically predict future infrastructure requirements based on forecast KPI data, as well as the corresponding costs of the predicted infrastructure requirements.

### CROSS REFERENCE TO RELATED APPLICATIONS

The present application is a continuation-in-part of U.S. patent application Ser. No. 16/831,811, filed on Mar. 27, 2020, titled “AUTOMATICALLY ALLOCATING NETWORK INFRASTRUCTURE RESOURCE COSTS WITH BUSINESS SERVICES,” the disclosure of which is incorporated herein by reference.

### BACKGROUND

A major shift in the software industry exists where the majority of new software is built for and deployed on public cloud providers—providers that provide on-demand availability of computer system resources, such as for example data storage and computing power, over a network such as the Internet and without direct active management by a user. Cloud providers typically charge their customers for the services used on a monthly basis, and provide a breakdown of the costs generated by such services which are specific to the particular cloud provider.

Most software companies have customers that require company software, which in turn uses company computing resources. It is difficult to determine what the requirements for customer success translate to in terms of computing resources provided by cloud providers. What is needed is an improved method for analyzing the costs associated with customer requirements.

### SUMMARY

The present technology, roughly described, automatically correlates infrastructure usage and cost data to key performance indicators for a software system. The present system continuously monitors the software system to detect operational events, key performance indicators, service degradation, and other events of a software system. The events may include the start and stop times of resource usage, memory usage, processor cycles used, and other data that may be expressed as time series data. The key performance indicator data can include the time of a transaction, login process, or other transaction, a number of deployments, number of active users, pipeline minutes for deployments, and other metrics, for example metrics associated with operations initiated directly or indirectly by a user or customer request or service usage.

The present system then correlates network infrastructure resource usage with key performance indicator data. The correlation can be performed using one of several techniques, including but not limited to a statistical model that utilizes statistical correlation and co-variance analysis. A correlation score is determined for a particular set of KPI data and the network infrastructure data. If the correlation score satisfies a threshold, the correlation is determined to exist. Based on detected correlations, the present system can automatically predict future infrastructure requirements based on forecast KPI data, as well as the corresponding costs of the predicted infrastructure requirements. The data, correlations, and predictions can be reported to a user, for example through a dashboard with graphical, metric, and other elements.

In some instances, a method for automatically allocating resource usage to key performance indicators receives, by an application server, event data from one or more delegates installed in one or more computing resources. The event data includes business service specific resource events. The application server can receive performance data associated with an operation initiated by a user. The application server can then correlate an infrastructure usage based on the event data with the performance data over a period of time. The infrastructure usage correlated to the performance data can be reported to a remote device associated with a customer.

In some instances, a non-transitory computer readable storage medium has embodied thereon a program. The program is executable by a processor to perform a method for automatically allocating resource usage to key performance indicators. The method includes receiving, by an application server, event data from one or more delegates installed in one or more computing resources. The event data includes business service specific resource events. The application server can receive performance data associated with an operation initiated by a user. The application server can then correlate an infrastructure usage based on the event data with the performance data over a period of time. The infrastructure usage correlated to the performance data can be reported to a remote device associated with a customer.

A system for automatically allocating resource usage to key performance indicators includes a server. The server includes a memory, a processor, and one or more modules, where the one or more modules are stored in memory and executable by the processor. The modules are executable to receive event data from one or more delegates installed in one or more computing resources, the event data including business service specific resource events, receive performance data associated with an operation initiated by a user, correlate an infrastructure usage based on the event data with the performance data over a period of time, and report the infrastructure usage correlated to the performance data to a remote device associated with a customer.

### BRIEF DESCRIPTION OF FIGURES

FIG. 1 is a block diagram of a system for automatically allocating network infrastructure resource usage with key performance indicators.

FIG. 2 is a block diagram of a continuous monitoring system.

FIG. 3 is a block diagram of a batch processor.

FIG. 4 is a method for automatically allocating network infrastructure resource usage with key performance indicators.

FIG. 5 is a method for collecting data by delegates in customer environments.

FIG. 6 is a method for associating KPI data to infrastructure usage.

FIG. 7 is a method for optimizing resource usage based on forecast KPI data.

FIG. 8 is a block diagram of a computing environment for implement in the present technology.

### DETAILED DESCRIPTION

The present system automatically correlates infrastructure usage and cost data to key performance indicators for a software system. The present system continuously monitors the software system to detect operational events, key performance indicators, service degradation, and other events of a software system. The events may include the start and stop times of resource usage, memory usage, processor cycles used, and other data that may be expressed as time series data. The key performance indicator data can include the time of a transaction, login process, or other transaction, a number of deployments, number of active users, pipeline minutes for deployments, and other metrics, for example metrics associated with operations initiated directly or indirectly by a user or customer request or service usage.

The present system then correlates network infrastructure resource usage with key performance indicator data. The correlation can be performed using one of several techniques, including but not limited to a statistical model that utilizes statistical correlation and co-variance analysis. A correlation score is determined for a particular set of KPI data and the network infrastructure data. If the correlation score satisfies a threshold, the correlation is determined to exist. Based on detected correlations, the present system can automatically predict future infrastructure requirements based on forecast KPI data, as well as the corresponding costs of the predicted infrastructure requirements. The data, correlations, and predictions can be reported to a user, for example through a dashboard with graphical, metric, and other elements.

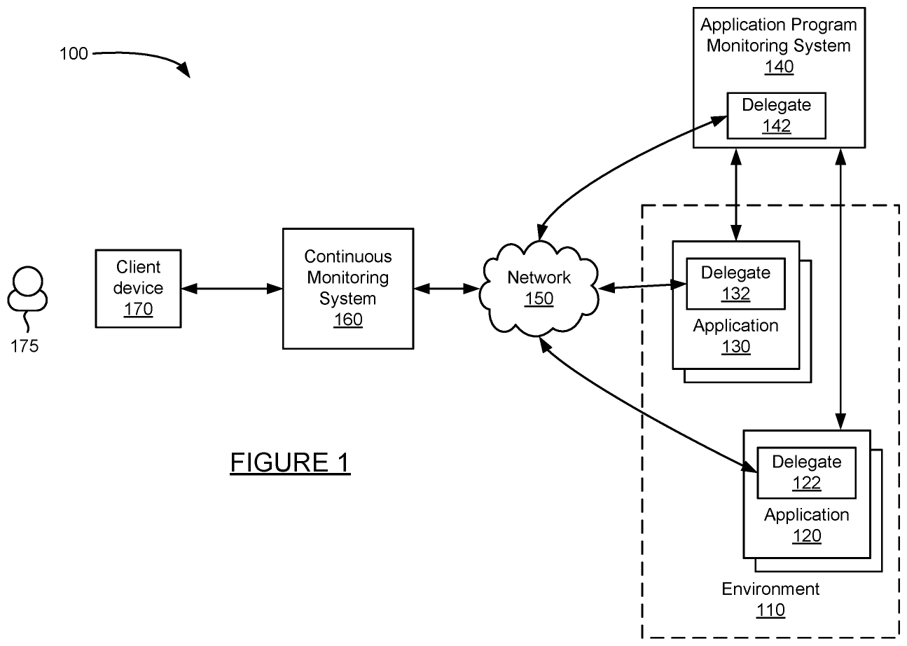

FIG. 1 is a block diagram of a system for automatically allocating network infrastructure resource usage with key performance indicators. System 100 of FIG. 1 includes environment 110, application program monitoring system 140, network 150, continuous monitoring system 160, and client device 170. Environment 100 may include one or more applications, such as for example application 120 and application 130, maintained and executed from one or more cloud computing services. Examples of cloud computing services can include Amazon Web services, Google Computing Platform, Microsoft Azure, and other cloud computing services. Thought only one environment is illustrated, multiple environments, each with one or more cloud computing services, may be used within the present system.

Network 150 may include one or more private networks, public networks, intranets, the Internet, an intranet, wide-area networks, local area networks, cellular networks, radio-frequency networks, Wi-Fi networks, any other network which may be used to transmit data, and any combination of these networks.

Continuous monitoring system 160 may continuously detect service performance, events, trends, and so forth, in the performance or behavior of one or more applications within environment 110 in real-time, for example before or after a software update is delivered to an application. To detect service regression, monitoring system 160 may monitor the applications either directly through delegates installed on the applications themselves, such as delegates 122, 132, and 142, or by access to real-time streaming monitoring data (including metrics or other data) provided by application program monitoring system 140.

A delegate may include an agent or other code that is installed to an application or system (e.g., host) and can communicate with remote systems and applications such as continuous monitoring system 160. Each delegate may receive instructions and tasks from monitoring system 160, retrieve information and transmit the information periodically or based on other events to monitoring system 160, may install new code or update code on an application or system, and perform other tasks and operations. In some instances, delegates may be installed on an application program monitoring system, such as a monitoring system provided by AppDynamics, Inc., of San Francisco Calif., to retrieve and transmit a stream of application performance metrics to delivery monitoring system 160. In some instances, delegates may be provided on one or more servers of an environment 120, such as servers hosting application 130 and application 136, to monitor applications and servers that include new code and those that did not host any new code (e.g., control servers).

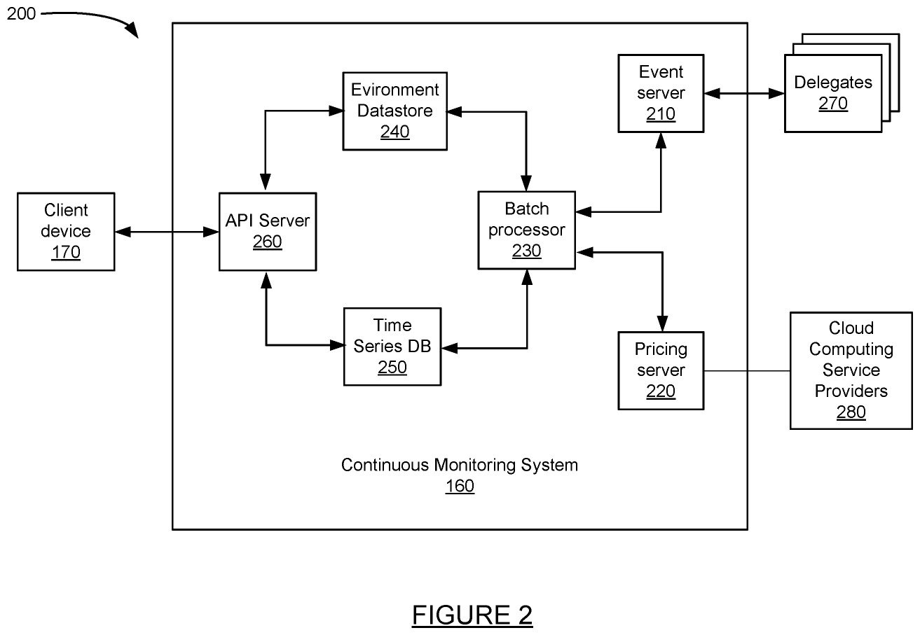

Continuous monitoring system 160 may provide continuous monitoring and continuous and customized correlation for a system. The continuous monitoring system can determine if there are any immediate or near-term issues, such as performance regression, and may provide reports and alerts based on the determination(s). The continuous monitoring system 160 may include a manager that manages tasks associated with the monitoring, utilization modules, clustering modules, a data store and other functionality. More details for a continuous monitoring system are discussed with respect to FIG. 2.

As monitoring system 160 provides continuous delivery and monitoring of new code, it may provide updates, alerts, notifications, and other information through one or more user interfaces to a user 175 via client device 170. The continuous monitoring system 160 can receive application data from delegates 122, 132, and 142 within cloud service providers to obtain event data, as well as communicate with cloud computing service provider applications (e.g., application program interfaces, or APIs) to obtain pricing data. The event data and pricing data can be used with business service data to correlate infrastructure usage and KPI data. Continuous monitoring system is discussed in more detail with respect to FIG. 2.

Client device 170 may be implemented as any computer that can receive and provide reports, alerts, and other data, such as for example through a user interface or dashboard, via a network browser, mobile application, or other application on a mobile device, smart phone, tablet, or any other computing machine. Reporting the status and results of continuous delivery service monitoring and automatically correlating network infrastructure resource usage with KPI data is discussed in more detail herein.

FIG. 2 is a block diagram of a continuous monitoring system. Continuous monitoring system of FIG. 2 provides more detail for continuous monitoring system 160 of the block diagram of FIG. 1. Continuous monitoring system 160 of FIG. 2 includes event server 210, pricing server 220, batch processor 230, environment datastore 240, time series database 250, and API server 260. Event server 210 may receive data from a plurality of delegates 260. The delegates 260 can include delegates 142, 132, and 122 of block diagram 100 of FIG. 1. The delegates detect events and report the events to event server 210. Event server 210 then provides the event data to batch processor 230.

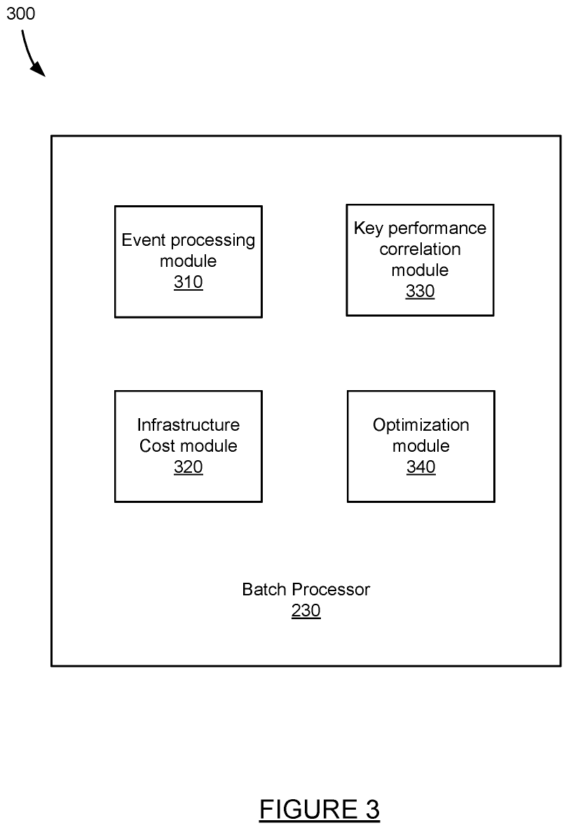

Batch processor 230 may receive event data and other data related to executing environments from event server 210. Batch processor may correlate and aggregate data and provide the data to environment data store 240 and time series database 250. Batch processor 250 is described in more detail with respect to FIG. 3.

The cloud computing service providers each have their own pricing information and schedules. The pricing information relates to costs for products and services provided by each particular cloud computing service. Pricing server 220 may retrieve costs for the products provided by each cloud computing service and provide the data to batch processor 230.

Environment data store may include a list of environments associated with business services implemented by a client. The environments may include development operations, engineering, finance, and other environments. The environments and identification information for each environment is provided to batch processor 230, which can correlate the environments to a subset of the events received from event server 210. Batch processor 230 generates timeseries data for each combination of environments and infrastructure usage and provides timeseries data to timeseries data base 250.

API server 250 receives client business environments data from environment datastore 240 and the correlated data from timeseries database 250, and provides interface data to client device 170. The data may be provided to client device 170 as a content page, dashboard, or in some other format for display or other communication to a client.

FIG. 3 is a block diagram of a batch processor 230. Batch processor 230 of FIG. 3 provides more details for the batch processor of FIG. 2. Batch processor 230 may include a plurality of modules that perform operations and functionality discussed herein. The modules illustrated in FIG. 3 are intended to be exemplary, and are not intended to limit the functionality performed by a batch processor the present technology.

Batch processor 230 includes event processing module 310, infrastructure cost module 320, key performance correlation module 330, and optimization module 340. Event processing module 310 receives event data from event server 210 and generates events from the event data. The events can be used to determine usage of infrastructure resources within particular environments. For example, the events may include a start time and stop time of usage for a virtual machine for a particular business service.

In some instances, different events may be detected for different cloud service providers, such as Kubernetes, Amazon Web Service, Microsoft Azure, Google Cloud Platform, and other services. For example, delegates may detect events such as the creation of a new deployment, a deployment autoscaling, pod container image update, service deployment, toggle of a feature flag, and other events. In some instances, for an Amazon Web Service, one or more delegates can detect events including but not limited to CloudWatch events (e.g., augmented AI events, auto-scaling events, batch events, and so forth), EC2 auto scaling events, EBS events, Config Events, EC2 state change events, and other events.

Infrastructure cost module 320 may receive pricing data from pricing server 220. The pricing data may be used to determine the cost of using a particular infrastructure resource for a cloud service provider. For example, pricing data can include an hourly cost of a virtual machine for a particular cloud service provider. In some instances, pricing data is retrieved for each service provider for which services or resources are used.

Key performance correlation module 330 may determine correlations between key performance indicators and resource event usage. For example, key performance correlation module may receive a list or other identification of key performance indicators, and receive data regarding those key performance indicators, for example through one or more delegates or other tracking or detection code. The key performance indicator data may be received periodically, such as for example every second, five seconds, 10 seconds, 30 seconds, one minute, or some other time period, or can be received based on the occurrence of an event, such as a detection of a new deployment. The key performance indicator data is received as time series data.

Key performance correlation module 330 can use algorithms and and/or other tools to correlate the KPI time series data with time series infrastructure resource data. The correlation can be performed in a variety of ways, including for example a statistical model analysis. A score may be generated by the KPI module 330 to determine the strength of the correlation. If the correlation score satisfies a threshold, the particular KPI and structure data can be considered closely correlated.

Optimization module 340 may process snapshots and trends of correlated infrastructure resources and KPI data to identify how to optimize use of a particular environment at the current time or in the future. For example, if a KPI forecast indicates a KPI will increase, the increase in the correlated infrastructure resources can be predicted. The actual available infrastructure resources can be compared to the predicted infrastructure resources required, and an alert can be generated if the actual infrastructure resources will not satisfy the predicted infrastructure resources.

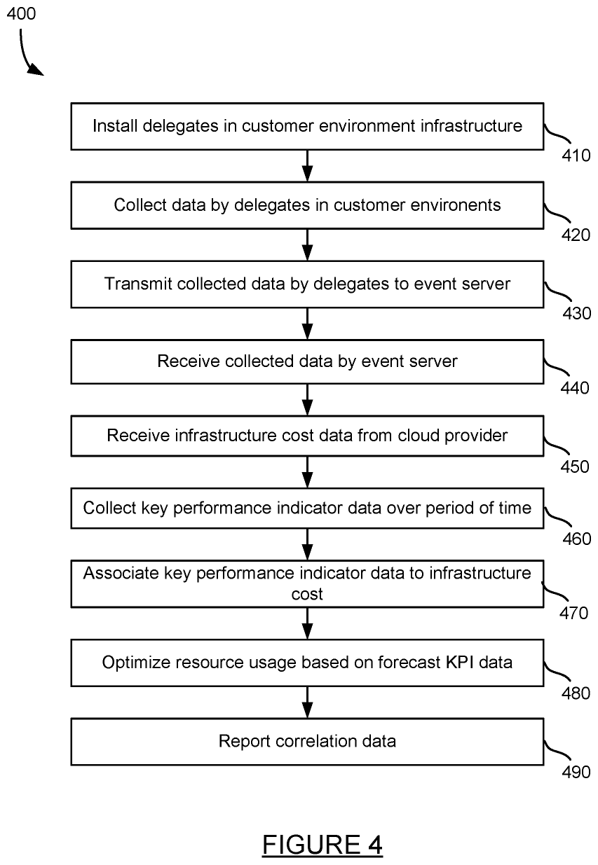

FIG. 4 is a method for automatically allocating network infrastructure resource usage with key performance indicators. First, delegates are installed in a customer environment infrastructure at step 410. Configuring an application with a delegate may include installing the delegate to the particular application (e.g., host) provided by a service provider. The application that receives the delegate is part of one or more customer environment infrastructure that includes all the applications used by the customer. The configuration may also include configuring the delegate with which data to capture, which managers (e.g., servers and applications) to communicate with, and other configuration tasks.

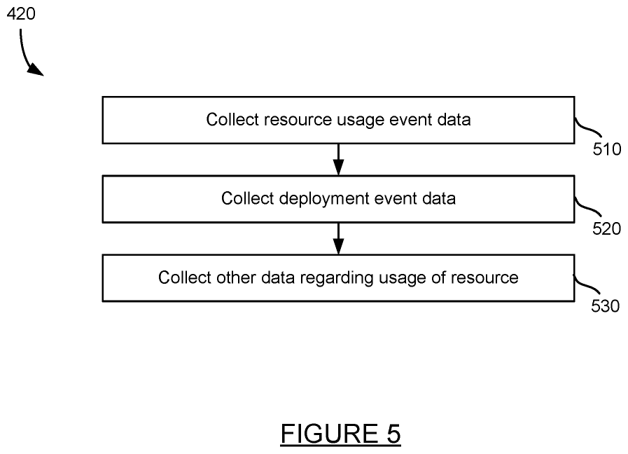

Data is collected by the delegates installed in the customer environments at step 420. The delegates may be installed in a plurality of environments, for example within one or more cloud computing services. More detail for step 420 is discussed with respect to the method of FIG. 5.

Collected event data is transmitted by delegates to an event server at step 430. The collected data is then received by the event server at step 440. Infrastructure cost data is received from one or more cloud providers by pricing server 220 at step 450. Infrastructure cost data may include pricing information for services subscribed to or purchased by the customer from a particular cloud provider.

Key performance indicator data is collected over a period of time at step 460. The KPI data may include one or more metrics, events, or other measurable elements that a company uses to determine how well a company is doing or progress towards an intended result. A KPI can create an analytical basis for decision-making and help focus attention on what matters to a particular company. In some instances, a KPI depends on how a company tracks use of its system by the customer. Examples of KPIs for a software as a service (SAS) company may include number of deployments, number of active users, pipeline minutes for deployments, time duration of a login, and other metrics. In some instances, other examples of a KPI may include a number of customers, how and when to use the software, deployments or verifications, and the number of infrastructures set up in an environment. In some instances, the present system may provide a number of KPIs by default. In some instances, one or more KPIs may be provided by a customer to the present system, and can be measured and tracked on an ongoing basis by the present system.

For each KPI, data may be collected over a period of time. The data may be collected periodically, such as every five seconds, 15 seconds, 30 seconds, minutes, two minutes, 10 minutes, hour, or some other period of time. In some instances, data may be collected in response to an event, such as the start time and end time of a login transaction. The collected data may be stored as a timeseries data.

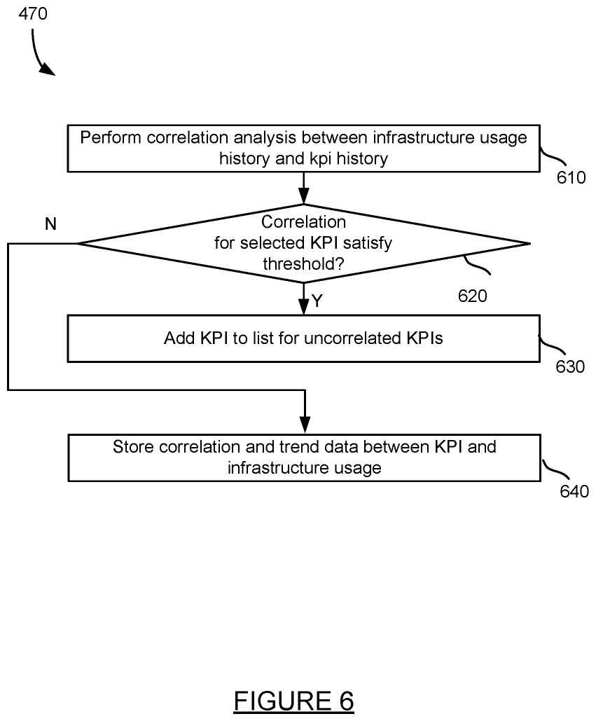

KPI data is associated with infrastructure resource data at step 470. To associate the KPI data to infrastructure resource data, a correlation analysis may be performed between infrastructure resource usage and a KPI data over a period of time. Correlation may involve a statistical model or some other correlation process. Associating KPI data with infrastructure resource data is discussed in more detail with respect to the method of FIG. 6.

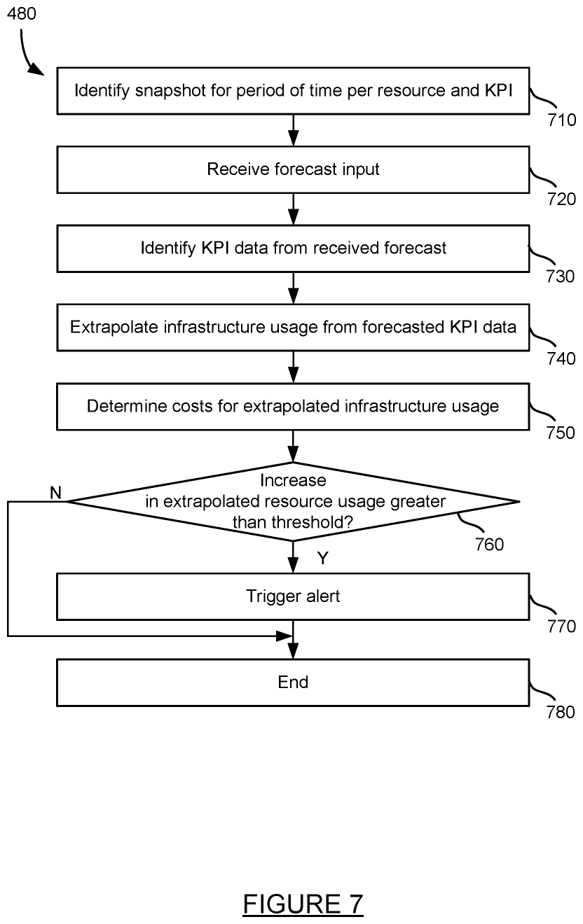

Resource usage is optimized based on forecasted KPI data at step 480. In some instances, businesses may be aware of predicted customer traction or utilization of their services. This prediction may be in the form of a forecast of key performance indicators. Infrastructure resource usage may be determined and optimized based on the forecast KPI data. Optimization may include determining costs for the infrastructure usage associated with the forecast KPI data. Additionally, resource usage can be optimized based on predicted KPI trends. More details for optimizing resource usage based on forecast KPI data is discussed with respect to the method of FIG. 7.

Correlation data may be reported at step 490. The correlation data may indicate the current KPI data and corresponding infrastructure resource data correlated to the KPI data. In some instances, were KPI data is received as incoming timeseries data or the data stream, the KPI data may vary as additional data comes in. In this instance, the corresponding infrastructure usage may also vary according to the varying KPI data that it is correlated with. The reporting of correlation data may be done through a dashboard, user interface, alerts, electronic messages, when some other format.

FIG. 5 is a method for collecting data by delegates in customer environments. The method of FIG. 5 provides more detail for step 420 the method of FIG. 4. First, resource usage event data is collected at step 510. Resource usage event data may include start and stop times for virtual machine usage, processing resources, and other resource events. Deployment event data can be collected at step 520. Deployment event data can include new deployments, and other events. Other data regarding the usage of a resource may be collected at step 530. The other data may include autoscaling events, state change events, and data for other events that relate to a service or resource obtained from a service provider.

FIG. 6 is a method for associating KPI data to infrastructure usage. The method of FIG. 6 provides more detail for step 470 of the method of FIG. 4. A correlation analysis is performed between infrastructure usage history and KPI data history at step 610. In some instances, the correlation analysis may include a statistical model correlation. In some instances, KPI timeseries data may be selected as well as infrastructure usage time series data. A statistical model correlation may be performed on the KPI timeseries data and infrastructure usage data, and a statistical model covariance analysis may also be performed. A correlation score may be generated based on the results of the statistical model correlation and statistical model covariance analysis. A correlation score may vary between 1 to 0, with 1 being a high level of correlation and 0 being no correlation. The next KPI timeseries data is then processed by the correlation and covariance analysis, and the correlation determination is continued.

A determination is made as to whether the correlation for the selected KPI satisfies a threshold at step 620. In some instances, the correlation score may be compared to a threshold score to determine if a correlation is strong enough to consider reliable. For example, if the correlation score is higher than a threshold of 0.5, 0.6, or 0.7, the correlation may be determined to satisfy the threshold. The threshold may be set to any value based on system designer or administrator preference. If the correlation does not satisfy the threshold at step 620, the KPI is added to a list of uncorrelated KPIs at step 640. In some instances, the KPI may be analyzed with subsequent infrastructure usage data to determine if it correlates with later data. If the correlation does satisfy the threshold at step 620, the correlation and trend data between the KPI and infrastructure usage is stored at step 630. The stored data may later be used to report to a user and optimize subsequent infrastructure usage for forecasted KPI data.

FIG. 7 is a method for optimizing resource usage based on forecast KPI data. The method of FIG. 7 provides more detail for step 480 the method of FIG. 4. First, a snapshot for a period of time is identified per resource and key performance indicator at step 710. Forecasted input is received at step 720. The forecast input may be a number of customers, a total sales figure, or some other forecasted data. KPI data can be identified from the received forecast at step 730. In some instances, KPI data can be determined from the forecast input. In some instances, the KPI data is the forecasted input.

Infrastructure usage may be extrapolated from the forecasted KPI data at step 740. When infrastructure usage is correlated to forecasted KPI data, the infrastructure usage corresponding to the forecast KPI data can be extrapolated for the correlation.

Costs for the extrapolated infrastructure usage may be determined at step 750. The costs may include financial costs, processing costs, memory costs, or some other associated costs of infrastructure. A determination is made as to whether an increase in extrapolated resource usage is greater than a threshold at step 760. The threshold may be set by an administrator, be tied to actual resources, or set based on other criteria. If the increase in the extrapolated resource usage is greater than a threshold, such as for example greater than a rate of increase, greater than the current resources available, or some other threshold of resource usage, an alert is triggered at step 770. The alert may indicate to an administrator that additional resources need to be acquired or activated in order to meet the extrapolated resource usage, or that the expected rate of increase or additional infrastructure may require additional components. The method then ends at step 780. If the extrapolated resource usage is not greater than the threshold, the method ends at step 780.

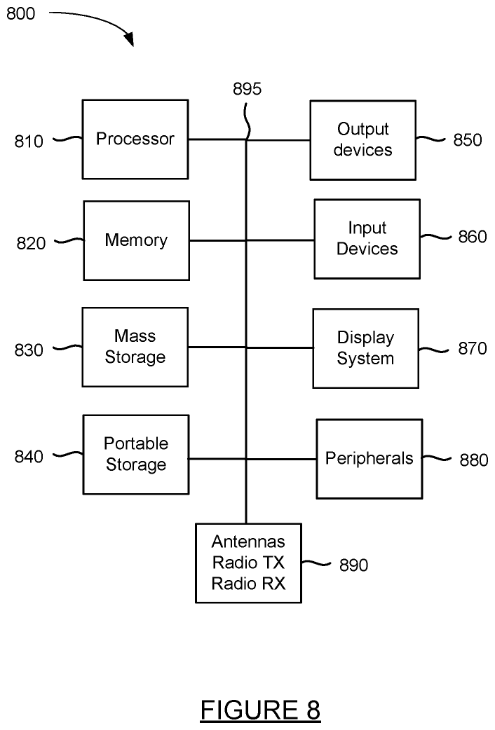

FIG. 8 is a block diagram of a system for implementing machines that implement the present technology. System 800 of FIG. 8 may be implemented in the contexts of the likes of machines that implement application program monitoring system 140, machines that host applications 120 and 130, continuous monitoring system 160, and machines that provide resources for cloud computing service providers 280. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive, an optical disk drive, a flash drive, or other device, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, USB drive, memory card or stick, or other portable or removable memory, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information and processes the information for output to the display device. Display system 870 may also receive input as a touch-screen.

Peripherals 880 may include any type of computer support device to add additional functionality to the computer system. For example, peripheral device(s) 880 may include a modem or a router, printer, and other device.

The system of 800 may also include, in some implementations, antennas, radio transmitters and radio receivers 890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically allocating resource usage to key performance indicators; comprising:
receiving, by an application server, event data from one or more delegates installed in one or more computing resources, the event data including business service specific resource events;
receiving, by the application server, performance data associated with an operation initiated by a user;
correlating, by the application server, an infrastructure usage based on the event data with the performance data over a period of time; and
reporting the infrastructure usage correlated to the performance data to a remote device associated with a customer.

2. The method of claim 1, further comprising determining an infrastructure cost correlated to the performance data by determining the infrastructure cost of the infrastructure usage which is correlated to the performance data.

3. The method of claim 1, wherein the performance data includes metrics generated from one or more operations initiated by the user.

4. The method of claim 1, wherein correlating includes using a statistical model to correlate infrastructure time series data and time series key performance indicator data.

5. The method of claim 1, wherein correlating includes performing a statistical model co-variance analysis.

6. The method of claim 1, wherein correlating includes determining a correlation score, and using the KPI data for correlation-based forecasting if the correlation score satisfies a threshold.

7. The method of claim 1, wherein the event data is received by the application server as time series data.

8. The method of claim 1, further comprising determining a projected infrastructure requirement based on forecast performance data and historic values of correlated infrastructure cost and performance data.

9. A non-transitory computer readable storage medium having embodied thereon a program, the program being executable by a processor to perform a method for automatically allocating resource usage to key performance indicators, the method comprising:
receiving event data from one or more delegates installed in one or more computing resources, the event data including business service specific resource events;
receiving performance data associated with an operation initiated by a user;
correlating an infrastructure usage based on the event data with the performance data over a period of time; and
reporting the infrastructure usage correlated to the performance data to a remote device associated with a customer.

10. The non-transitory computer readable storage medium of claim 9, further comprising determining an infrastructure cost correlated to the performance data by determining the infrastructure cost of the infrastructure usage which is correlated to the performance data.

11. The non-transitory computer readable storage medium of claim 9, wherein the performance data includes metrics generated from one or more operations initiated by the user.

12. The non-transitory computer readable storage medium of claim 9, wherein correlating includes using a statistical model to correlate infrastructure time series data and time series key performance indicator data.

13. The non-transitory computer readable storage medium of claim 9, wherein correlating includes performing a statistical model co-variance analysis.

14. The non-transitory computer readable storage medium of claim 9, wherein correlating includes determining a correlation score, and using the KPI data for correlation-based forecasting if the correlation score satisfies a threshold.

15. The non-transitory computer readable storage medium of claim 9, wherein the event data is received by the application server as time series data.

16. The non-transitory computer readable storage medium of claim 9, further comprising determining a projected infrastructure requirement based on forecast performance data and historic values of correlated infrastructure cost and performance data.

17. A system for automatically allocating resource usage to key performance indicators, comprising:
a server including a memory and a processor; and
one or more modules stored in the memory and executed by the processor to receive event data from one or more delegates installed in one or more computing resources, the event data including business service specific resource events, receive performance data associated with an operation initiated by a user, correlate an infrastructure usage based on the event data with the performance data over a period of time, and report the infrastructure usage correlated to the performance data to a remote device associated with a customer.

18. The system of claim 17, the one or more modules further executable to determine an infrastructure cost correlated to the performance data by determining the infrastructure cost of the infrastructure usage which is correlated to the performance data.

19. The system of claim 17, wherein the performance data includes metrics generated from one or more operations initiated by the user.

20. The system of claim 17, wherein correlating includes using a statistical model to correlate infrastructure time series data and time series key performance indicator data.
